(19) United States
(12) Patent Application Publication
(10) Pub. No.: US 2020/0349803 A1
(43) Pub. Date: Nov. 5, 2020

(54) GAMING CONSOLE SYSTEM

(71) Applicant: Huuuge Global Ltd., Larnaca (CY)

(72) Inventor: Wojciech Wronowski, Szczecin (PL)

(73) Assignee: Huuuge Global Ltd., Larnaca (CY)

(21) Appl. No.: 16/857,922

(22) Filed: Apr. 24, 2020

(30) Foreign Application Priority Data
Apr. 30, 2019 (FI) FI U20194064

(51) Int. Cl. G07F 17/32

(52) U.S. Cl. CPC G07F 17/3223; G07F 17/3297; G07F 17/3244; A63F 9/30; G07F 17/3211; G07F 17/3225; G07F 17/3209

(57) ABSTRACT

A game machine system that includes a remotely controllable game machine, a support arrangement for a web camera. The web camera is attachable by means of the support arrangement to capture video of the game machine. The game machine system further includes a communication interface for a remote control of the remotely controllable game machine.

### FIELD

The aspects of the disclosed embodiments is a game machine system.

### BACKGROUND

Use of game machines is limited to physical premises into which players come to play a game machine. There are a lot of different game machines. This creates limitations on offering players a versatile gaming experience. The requirement of a physical space creates limitations to players who are not in big cities. It is not economically viable to run game machines or game machine arcades in small localities.

It would be advantageous to allow remote use of a game machine such that the players obtain as real a gaming experience as possible.

### SUMMARY

The aspects of the disclosed embodiment relates to a game machine system, comprising a remotely controllable game machine; a support arrangement for a web camera; the web camera attachable by means of the support arrangement to capture a video of the game machine; and a communication interface for a remote control of the remotely controllable game machine. The game machine system thus comprises a remotely controllable game machine. The game machine can be any physical game machine that the player could also use locally (i.e. while being in physical contact with the game machine). An example of a game machine is a claw game in which the purpose is to steer the claw above the prizes by using a physical game controller so that the player gets the prize. The prizes of the claw game are in the physical space inside the game machine. When using such a game machine, the player steers the claw in XY plane in remote control. When the player thinks the claw is in a suitable location, the player commands the claw to lower down and tries to lift a prize from a pile of prizes. The claw mechanism delivers the (possibly) won prize within the player's reach. In an arrangement according to the invention, the player is offered a possibility to control remotely the game machine via a communication interface. For example, a web interface may function as the communication interface. The game machine system further comprises a web camera by means of which the player sees the remotely controllable game machine. The web camera is arranged to capture a video the game machine (when in use). The captured video of the game machine (and its operation) can be provided to the player through a streaming media by using Internet Protocol (IP) technology. The web camera is attachable by means of a support arrangement so that a video (or still images) of the game machine can be captured with the web camera. The support arrangement can be attached to the remotely controllable game machine or it can be arranged for example to a separate pole or to the ceiling.

According to an embodiment, the game machine comprises a physical controller to control the game machine. The physical controller in question can be arranged to be controlled with a remotely controllable control motor. In this embodiment, there is no need to make modifications to the electronics or the mechanics of the game machine as such. The control motor and the mechanics related thereto are arranged to make the same moves as the player would make with his hand, if the player played the game locally. Alternatively, the remote control can directly control the electronics and/or the logics of the game machine by producing the corresponding control signals to the game machine that the physical controller of the game machine would produce. The physical controller is remotely controllable, thus enables to convert existing game machines to be used remotely while preserving real gaming experience.

According to an embodiment, the support arrangement of the web camera allows to physically move the camera. In this embodiment, there are one or more remotely controllable control motors in the support arrangement. With the control motors, the viewing angle of the web camera can be changed, i.e. the support arrangement of the web camera comprises one or more remotely controllable control motors to change the viewing angle of the web camera. In this way, a player can choose the viewing angle and the distance to the game machine according to his own preferences. Furthermore, according to an embodiment, the web camera can be a combination of two cameras (a 3D camera) whereby through it, it is possible to observe the game machine in three-dimensions (for example via virtual reality display system).

According to an embodiment, the game machine system comprises a prize delivery arrangement. As players are not physically in the same place as the game machines, it is possible to arrange in connection with the game machine a delivery arrangement including a mailing arrangement. The won prize can be delivered by means of a conveyor belt for packing and to be sent to the player. If the prize is a cash prize (for example if the game machine is a so-called one-armed bandit), the prize sum can be transferred as a money transfer to the player's account. Additionally, the game machine system can contain an apparatus for trying to get a prize. The apparatus can be for example a claw mechanism, rotating gears of a fruit game, a mechanism of a coin game moving the coins or a gun and a target of a shooting game. This apparatus can be placed such that a video of the apparatus can be captured with a web camera (or a web camera can be placed such that the apparatus can be seen in the video of the web camera).

According to an embodiment, the game machine system is arranged to be in connection with a server system via a communication interface. The communication interface can be a communication network such as Internet. The server system may have means for remotely controlling one or more game machines and for displaying an image or video captured by a web camera. The video captured with the web camera can be provided either for just one player to watch or it can be provided to several players, i.e. the video captured with the web camera can be displayed in one or more user terminals. For example, the persons waiting for the same game machine can be given a chance to observe the performances of the previous player(s). A means of the server system can be a web portal offering a chance to play one or more different games. A means of the server system can alternatively be a software to which the players register and thereby get a chance to control remotely one or more game machines. The means of the server system can include a billing system for charging of the playing. The remote control of the game machine can be implemented as its own connection to the server system separate from the connection of the (video) image of the web camera. The means of the server system can connect the image of the web camera with the game machine. Players can use the game machine system on user terminals. For example, a smart phone, a laptop, a browser device or a computer can function as a user terminal. Using can mean either playing or being spectator of a game play.

The game machine of the game machine system can be a so-called one-armed bandit, a claw game, an adventure game or a coin dropping game. By means of a server system, a player can be offered a chance to play one or more game machines and be offered a chance to follow the gaming event of one or more game machines.

### DESCRIPTION OF THE FIGURES

The aspects of the disclosed embodiments are described in more detail in the appended Figures that are not to be construed as limiting the invention.

FIG. 1 depicts a game machine system.

FIG. 2 depicts a game machine system.

FIG. 3 depicts three remotely controllable game machines.

### BRIEF DESCRIPTION OF THE DISCLOSED EMBODIMENTS

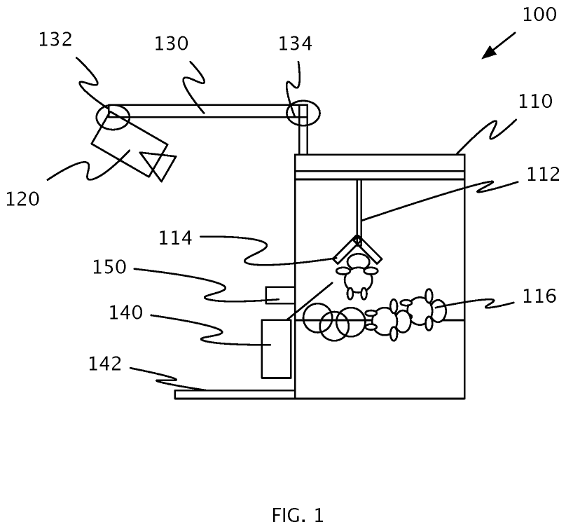

FIG. 1 depicts a game machine system 100. There is a game machine 110 in the game machine system 100. The game machine 110 has an apparatus for trying to get a prize. The apparatus has a first part that is an arm 112 movable in the XY direction and a second part that is a claw 114 that can be lowered downwards in the Z direction. The claw 114 grabs the prize 116, if the prize 116 is located under the claw 114. The obtained prize 116 is dropped via a hatch 140 to the delivery system 142. In FIG. 1, the delivery system 142 is a conveyor belt. The claw 114 can be controlled with a physical controller 150. The physical controller 150 gets the control commands in remote control according to the embodiment.

Further, FIG. 1 depicts a web camera 120. The web camera 120 is attached by means of a support arrangement 130 of the web camera to the game machine 110. In the support arrangement, there are two remotely controllable control motors 132, 134. With these, the viewing angle of the web camera 120 as well as the viewing distance in relation to the game machine 110 can be changed.

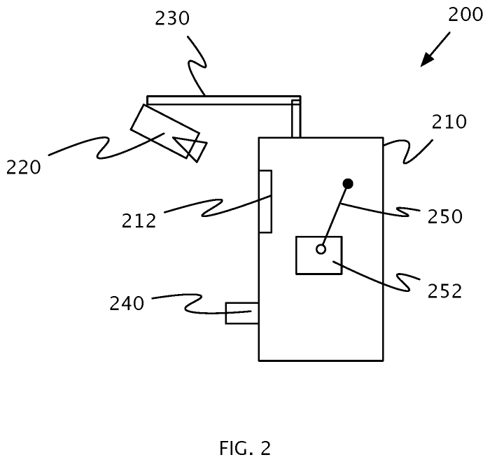

FIG. 2 depicts a game machine system 200 wherein the remotely controllable game machine 210 is a one-armed bandit (known also as a fruit game). The game machine has a physical controller 250. The physical controller is a lever by pulling of which an apparatus for trying to get a prize (gears 212 containing symbols) of the one-armed bandit start to rotate. If the player gets for example three same symbols in a row, the player wins. A control motor 252 has been arranged to be fastened to the lever. The control motor 252 turns the lever after having received the remote-control command. The game machine 210 contains a prize delivery system 240. A money transfer arrangement wherein the prize sums are deposited on the player's game account functions preferably as a delivery system. Alternatively, coins coming from the game machine can be delivered to the player.

Additionally, FIG. 2 shows a web camera 220. The web camera 220 is directed towards the gears 212 and towards the lever 250. The support arrangement 230 of the web camera in FIG. 2 is fixed.

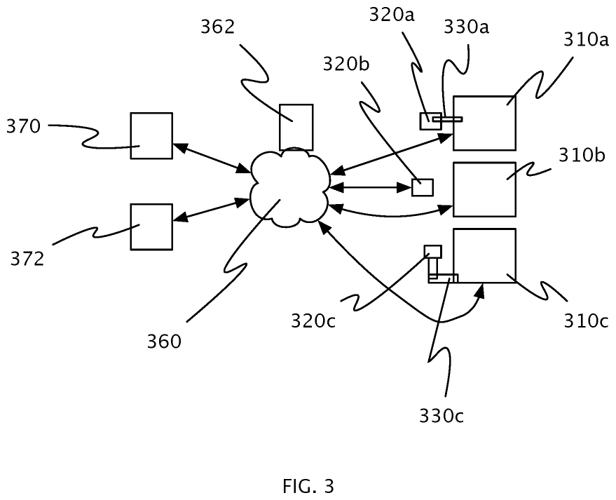

FIG. 3 depicts three remotely controllable game machines 310a, 310b and 310c. A support arrangement 330a of a web camera and a web camera 320a have been attached to the game machine 310a. The game machine 310a is in connection with a server system 362 through a communication network 360. A support arrangement 330c of a web camera and a web camera 320c have been attached to the game machine 310c. The game machine 310c is in connection with the server system 362 through the communication network 360. The game machine 310b is also in connection with the server system 362 through the communication network 360. In the vicinity of the game machine, there is a web camera 320b attached to the ceiling of the game machine arcade such that the web camera 320b is directed towards the game machine 310b. The web camera 320b is in connection with the server system 362. The game machine 310b and the camera image from the web camera 320b are combined to each other in the server system 362.

Players using the game machine system control and watch the video image coming from the web cameras by means of user terminals 370 and 372.

1. A game machine system, comprising
a remotely controllable game machine;
a support arrangement for a web camera;
the web camera, attachable by means of the support arrangement to capture video of the game machine; and
a communication interface for a remote control of the remotely controllable game machine.

2. A game machine system according to claim 1, wherein the game machine comprises a physical controller for controlling the game machine, the physical controller being arranged to be controlled by means of a remotely controllable control motor.

3. A game machine system according to claim 1, wherein the support arrangement for the web camera comprises one or more remotely controllable control motors for changing the viewing angle of the web camera.

4. A game machine system according to claim 1, wherein the game machine comprises a prize delivery arrangement.

5. A game machine system according to claim 4, wherein the game machine comprises an apparatus for trying to get a prize, the apparatus being arranged such that it can be filmed with a web camera.

6. A game machine system according to claim 1, configured to arranged to be in connection with a server system via a communication interface, wherein the server system contains means for remotely controlling one or more game machines and for displaying a video captured with the web camera in one or more user terminals.

7. A game machine system according to claim 1, wherein the game machine is chosen from a group comprising a one-armed bandit, a claw game, an adventure game and a coin dropping game.
